(19) United States
(12) Patent Application Publication
(10) Pub. No.: US 2026/0126570 A1
(43) Pub. Date: May 7, 2026

(54) RETROREFLECTOR FOR VEHICLES

(71) Applicant: Hella GmbH & Co. KGaA, Lippstadt (DE)

(72) Inventors: Carsten Hohmann, Warstein (DE); Martin Mügge, Geseke (DE)

(21) Appl. No.: 19/371,399

(22) Filed: Oct. 28, 2025

(30) Foreign Application Priority Data
Nov. 6, 2024 (DE) 102024132312.4

(51) Int. Cl. G02B 5/122; B60Q 1/26

(52) U.S. Cl. CPC G02B 5/122; B60Q 1/26

(57) ABSTRACT

A retroreflector for vehicles is provided with a retroreflector element containing numerous reflecting surfaces at an angle to one another, at which light entering the retroreflector element is reflected back toward its source. The retroreflector element also includes a light-entry surface. The reflecting surfaces of the retroreflector element are on a back surface lying opposite the light-entry surface and/or on one of the lateral surfaces connecting the light-entry surface to the back surface. Opposing edges of the light-entry surface are at a distance (a) of at least 5 mm to one another. At least one fastening element protrudes from the retroreflector element.

### CROSS REFERENCE

This application claims priority to German Application No. 10 2024 132312.4, filed Nov. 6, 2024, the entirety of which is hereby incorporated by reference.

### FIELD OF THE INVENTION

The invention relates to a retroreflector for vehicles that has a retroreflector element containing numerous reflecting surfaces that are at an angle to one another at which light entering the retroreflector elements is reflected back toward the source, and which has a light-entry surface.

### BACKGROUND OF THE INVENTION

A retroreflector for vehicles is disclosed in DE 100 37 007 A1, which is composed of numerous triplets of retroreflector elements and is integrated in a signal light on the back of the vehicle. The respective retroreflector triplets have three reflecting surfaces at an angle to one another at which the light is reflected back toward its source. To obtain the necessary level of the retroreflection, there are numerous such little retroreflector triplets. Both the number and proportion of edges to the size of the reflective surfaces are relatively large. It would be preferable to increase the efficiency with the lowest possible number reflective surfaces.

A retroreflector for vehicles is disclosed in EP 1 176 359 A2 that has numerous retroreflector triplets in which these triplets are placed in a field of light sources, alternating therewith. Numerous retroreflector triplets are needed to obtain the necessary level of retroreflection.

A retroreflector for construction sites is disclosed in DE 10 2018 101 292 A1, which has numerous retroreflector triplets forming the retroreflector elements. These triplets have reflecting surfaces that are nearly perpendicular to one another. The size of these triplets is such that have a lateral extension of 2 mm to 3 mm, or 200 μm to 300 μm.

### BRIEF SUMMARY OF THE INVENTION

The object of the present invention is to design a retroreflector for vehicles with which the efficiency is increased in a simple manner.

This problem is solved conjunction with the preamble of claim 1, in that the invention is characterized by reflecting surfaces of the retroreflector elements on a back surface opposite the light-entry surface and/or on one of the lateral surfaces connecting the light-entry surface to the back surface, opposing edges of the light-entry surface are at least 5 mm apart, and there is at least one fastening element protruding from the retroreflector element.

The particular advantage of the invention is that by enlarging the reflecting surfaces and/or the light-entry surface, it is possible to substantially reduce the overall lengths of the edges necessary for this. The disruptive effects of these edges to the efficiency of the retroreflector can thus be reduced. Another advantage is that the relatively large retroreflector elements therein can be used as design elements that harmonize with the optical surfaces of signal lights. The retroreflector element with its faceted surfaces can be integrated in the design of the signal lights.

The light-entry surface on the retroreflector element can be flat. The reflecting surfaces of the retroreflector element are on the back or a side thereof. The retroreflector element is therefore shaped like a diamond.

A projection of the light-entry surface on the retroreflector element onto a surface that is perpendicular to the normal thereof covers the back surface and/or lateral surfaces of the retroreflector element. The light-entry surface therefore determines the size of the front of the retroreflector element.

The retroreflector element is a polyhedron, e.g. a cube or octahedron, or an elongated square pyramid. The three-dimensional shape of the retroreflector elements can be selected on the basis of the desired design for the light signature.

The numerous retroreflector elements can be spaced apart, in which case the spaces between them are filled with optical elements for a signal light. The sizes of the reflecting surfaces in the retroreflector element correspond to those of the optical elements, such that a uniform appearance is obtained. This allows for a homogenous optical integration in a signal light.

The numerous retroreflector elements can be arranged in a geometric pattern. They can form a circle, hexagon, or square on a surface of a signal light, for example.

The retroreflector element can have at least two mounting brackets protruding from the sides of the retroreflector element. This allows for the retroreflector element to be placed in a frame from the back and secured therein with an adhesive, welding, screws, or a thermal bond. The frame has an opening corresponding to the size of the light-entry surface, such that the light-entry surface is flush with the surface of the frame.

The retroreflector element can have a collar encompassing the light-entry surface at the front, with and edge contour with which it can be tightly fit into an opening in the frame, preferably in a signal light. This frame can also form a faceplate.

Numerous retroreflector elements can be directly adjacent and integrally connected to one another to form a retroreflector unit. This results in a compact retroreflector.

The retroreflector elements or unit can have lateral mounting brackets with fastening elements. Consequently, the retroreflector elements or unit can be integrated in a slanted surface on the body of the vehicle or a signal light on the vehicle.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a perspective view of a first embodiment of a retroreflector element.

FIG. 2 shows the retroreflector element in FIG. 1 with light beams indicated by arrows.

FIG. 3 shows a retroreflector element from the front with a hexagonal light-entry surface.

FIG. 4 shows another embodiment of a retroreflector element from the side.

FIG. 5 shows a cube-shaped retroreflector element from the side.

FIG. 6 shows numerous cube-shaped retroreflector elements arranged in a circle.

FIG. 7 shows a retroreflector unit from the front, with numerous cube-shaped retroreflector elements.

FIG. 8 shows the retroreflector unit in FIG. 7 from the side.

FIG. 9 shows a retroreflector element from the front, with integrated fastening elements on the front.

FIG. 10 shows the retroreflector element in FIG. 9 from the back.

FIG. 11 shows a retroreflector element from the front, with fastening elements on the side.

FIG. 12 shows the retroreflector element in FIG. 11 from the back.

FIG. 13 shows the retroreflector element in FIGS. 11 and 12 in a frame from the front.

FIG. 14 shows the retroreflector element in FIGS. 11 and 12 in a frame from the back.

FIG. 15 shows a retroreflector unit from the front, with fastening elements on the side, composed of numerous retroreflector elements integrally connected to one another.

FIG. 16 shows the retroreflector unit in FIG. 15 from the back.

FIG. 17 shows a perspective view of a retroreflector element that has a lateral fastener on the side.

FIG. 18 shows the retroreflector element with the lateral fastener from the back.

FIG. 19 shows a perspective view of the retroreflector element with the lateral fastener, diagonally from the back.

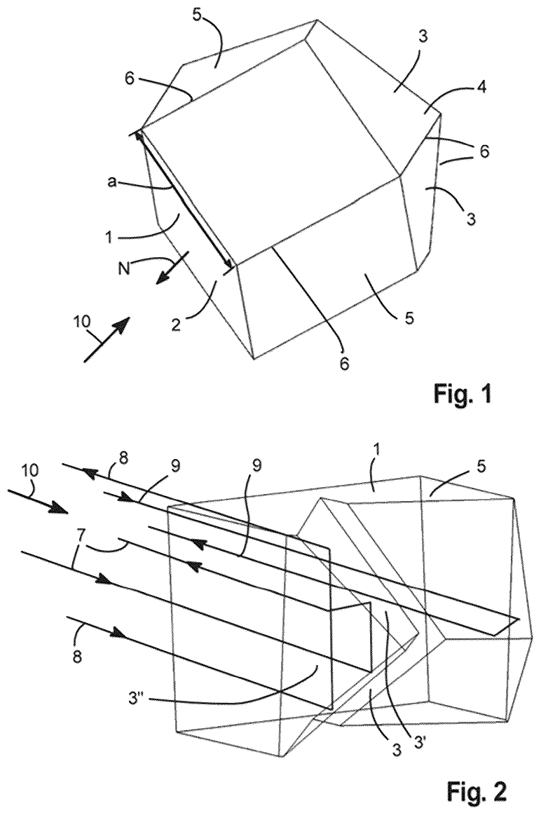

### DETAILED DESCRIPTION OF THE INVENTION

The retroreflector for vehicles obtained with the invention is preferably placed on the back of the vehicle. By way of example, it can be a separate retroreflector in an opening in the vehicle body, or it can be integrated in a signal light.

This retroreflector has just one retroreflector triplet (retroreflector element) 1, in the form of a polyhedron, which has one light-entry surface 2 and numerous, specifically three, reflecting surfaces 3 that are at an angle to one another.

The retroreflector element 1 is a solid body shaped somewhat like a diamond.

The reflecting surfaces 3 of the retroreflector element 1 are on the back 4 of the retroreflector element 1, lying opposite the light-entry surface 2.

At least one of the reflecting surfaces 3 could also be on one of the lateral surfaces 5 of the retroreflector element 1, which connects the light-entry surface 2 on the front of the retroreflector element 1 to a reflecting surface 3 on the back 4 of the retroreflector element 1.

The light-entry surface 2, reflecting surfaces 3, and lateral surfaces 5 are connected to one another at the edges 6. The reflecting surfaces 3 meet the adjacent reflecting surfaces 3 at an obtuse angle.

The light-entry surface 2 is flat. A projection of the light-entry surface 2 onto a surface that is perpendicular to the normal N thereof covers the reflecting surfaces 3 at the back, in particular the back 4 of the retroreflector element 1. At least one lateral surface 5 can extend beyond the projection of the light-entry surface 2, such that it is not covered by it.

As shown in FIG. 2, the reflecting surfaces 3 are placed such that a first light beam 7 traveling along the angle of incidence 10 is reflected at a first reflecting surface 3, second reflecting surface 3′, and third reflecting surface 3″, and then back through the light-entry surface 2 toward the source. A second light beam 8 and third light beam 9 are each reflected at just two reflecting surfaces 3 of the retroreflector element 1, and then exit back toward the source.

The light-entry surface 2 on the retroreflector element 1 in the first embodiment is square. Opposing edges 6 thereof are at a distance a that is greater than 5 mm. This distance a between opposing edges 5 is preferably at least 8 mm, ideally between 10 mm and 16 mm. The retroreflector element 1 is therefore relatively large. The edges 6 of the retroreflector element are relatively short in relation to the overall size of the light-entry surface 2 and the reflecting surfaces 3, 3′, 3″. In addition to simplifying production, the efficiency of the retroreflector is improved by this, because the size of the reflecting surfaces 3, 3′, 3″ is increased in relation to the size of the light-entry surface 2 of the retroreflector.

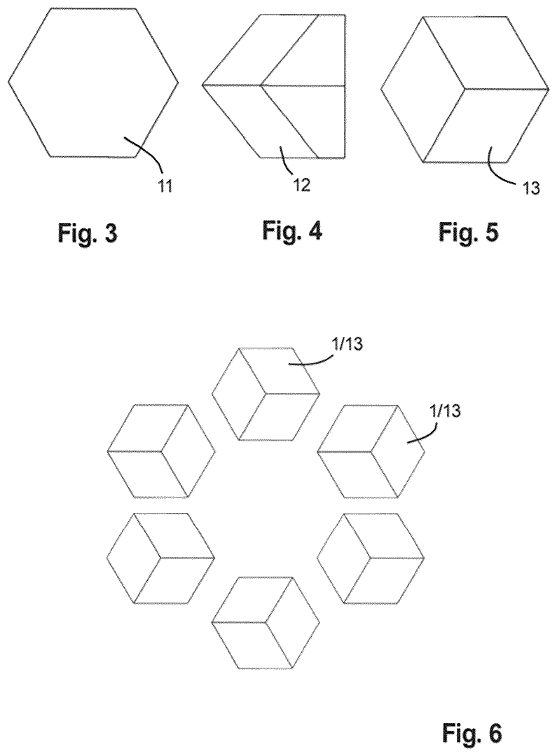

The retroreflector element 11 can be a truncated tetrahedron, as shown in FIG. 3. It can also be an elongated triangular pyramid, as shown in FIG. 3. The retroreflector element 13 can also be a cube.

The retroreflector element 1 can also be an elongated square pyramid or triangular pyramid.

The retroreflector shown in FIG. 6 is formed by numerous retroreflector elements 13 arranged in a circle. The individual retroreflector elements 13 can be placed in separate housings or in a single housing. The retroreflector elements 13 can thus be placed in a geometric pattern in relation to one another, preferably in the same plane.

The retroreflector elements are spaced apart, and the space between them is filled by optical elements for a signal light or an opaque surface, e.g. the surface of the vehicle body.

The retroreflector elements 13 can also be placed in vertical or horizontal rows, or in offset horizontal or vertical rows (not shown in the drawings).

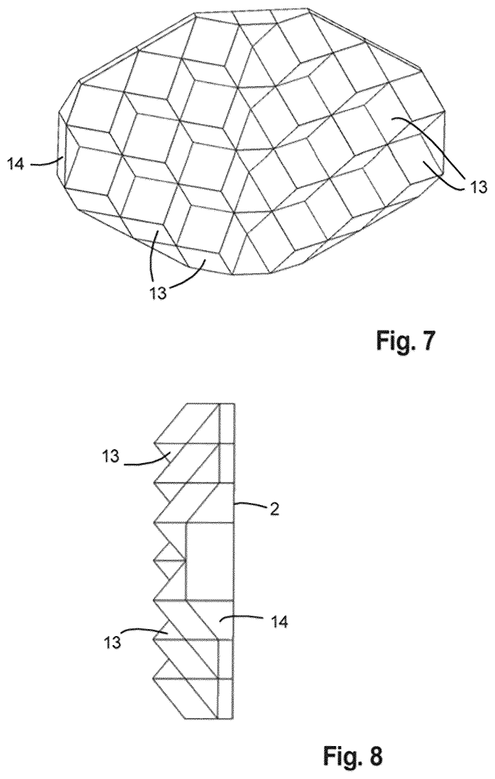

FIG. 7 shows an embodiment of the invention with numerous retroreflector elements 13 that are directly adjacent and integrally connected to one another to form a retroreflector unit 14 that can be placed in an opening in the vehicle body (not shown).

Depending on design requirements, the retroreflector unit 14 can have a circular or polygonal outer contour instead of the elliptical shape shown in FIG. 7.

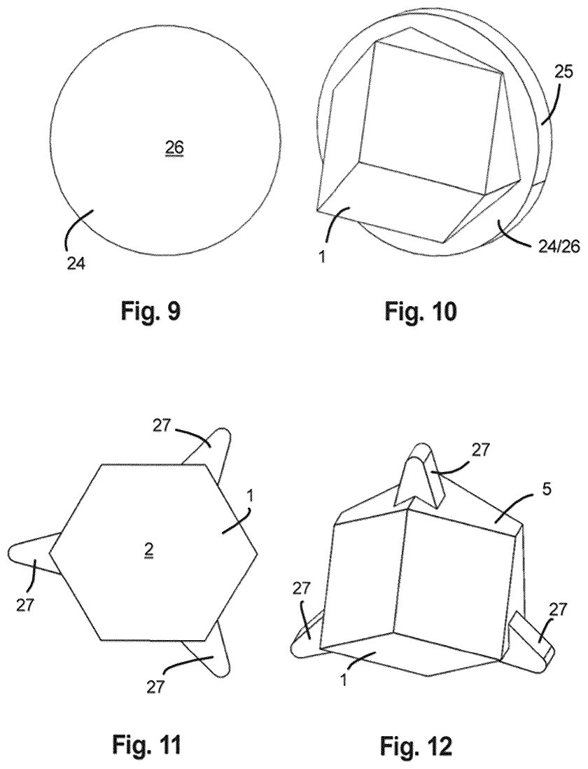

As FIGS. 9 and 10 show, the retroreflector element 1 can have a fastening collar 24 on the front with an edge that corresponds to an opening in a frame (not shown). This collar 24 encompasses the light-entry surface 2 in this exemplary embodiment and has a circular edge 25. This edge 25 fits into the opening in the frame. The collar 24 can be glued, welded, screwed, or thermally bonded into the frame.

By way of example, the collar 24 can be part of a fastening plate 26 formed on the light-entry surface 2 on the retroreflector element 1. The frame preferably has a flange at the front edge for the collar 24 or the plate 26 thereon. This is where the retroreflector element 1 is glued or welded to the frame.

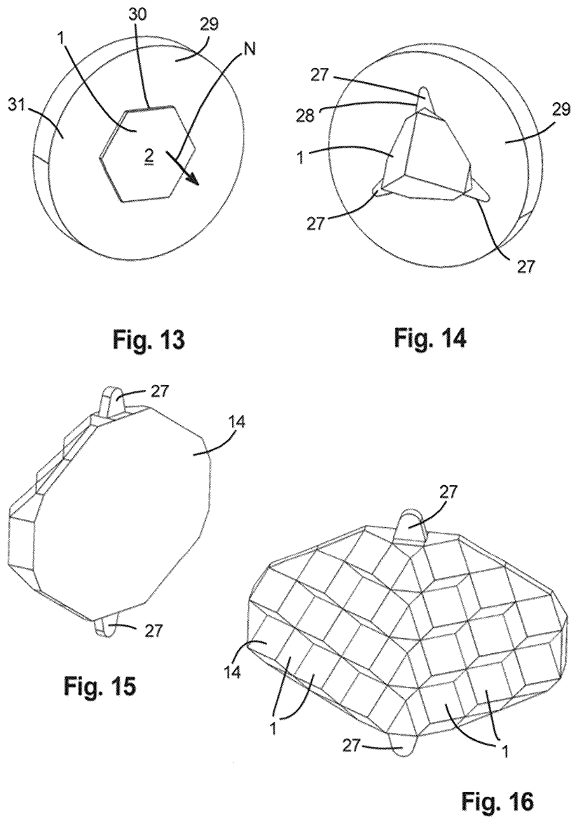

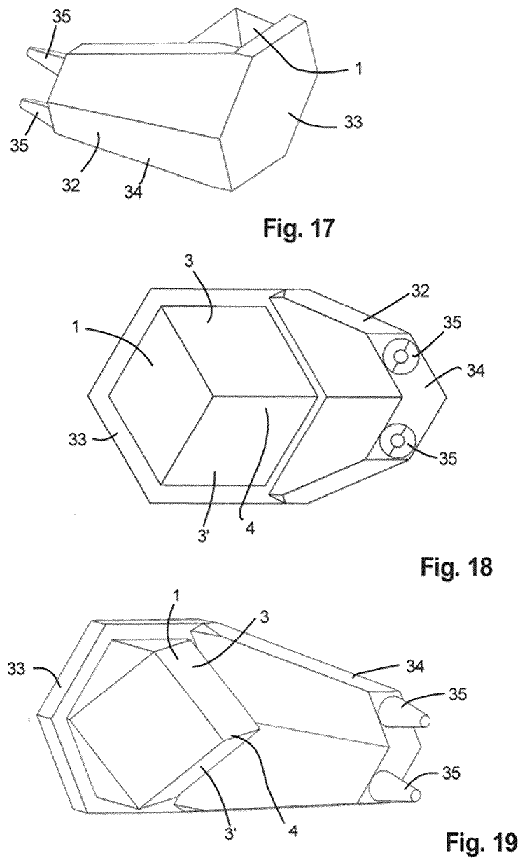

The embodiment shown in FIGS. 11 to 14 has numerous fastening elements 27 on the sides of the retroreflector element 1, which can preferably be placed tightly into corresponding pockets 28 in the frame. The fastening elements 27 are webs protruding from the lateral surfaces 5 of the retroreflector element 1, which preferably taper toward their outer ends.

The frame 29 preferably has an opening 30, the shape of which corresponds to the shape of the light-entry surface 2 on the retroreflector element 1. In this exemplary embodiment, the opening 30 is hexagonal, corresponding to the rectangular shape of the light entry surface 2 on the retroreflector element 1.

Because a projection of the light-entry surface 2 in the direction of the normal N thereof, and in the installation direction, covers the reflecting surfaces 3, 3′, 3″ and the lateral surfaces 5, the retroreflector element 1 can be inserted into the opening 20 in the frame 29 from the back until the fastening webs 27 fit into the pockets 28. At this point, the light-entry surface 2 of the retroreflector element 1 is flush with the front surface 31 of the frame 29. The retroreflector element 1 can then be welded, glued, or thermally bonded in place to secure it in the frame.

In the embodiment shown in FIGS. 15 and 16, the fastening elements 27 can also be placed on the sides of the retroreflector unit 14. It is then placed in the frame 29 from the back, as in the previous embodiment, such that there are no gaps formed on the front of the frame 29.

If the retroreflector element 1 has to be integrated in a slanted surface on the body of the vehicle or a signal light, there is a lateral fastener 32, as shown in FIGS. 19 to 21, which is integrally connected to the retroreflector element 1. The lateral fastener 32 is on the side of the retroreflector element 1, extending from the light-entry surface 2 to the reflecting surfaces 3, 3′.

In this exemplary embodiment, the lateral fastener 32 has a fastening plate 33 that is placed on the light-entry surface 2 of the retroreflector element 1 and covers the edge thereof. The lateral fastener 32 also has a mounting bracket 34 on the side of the fastening plate 33 at a distance to the retroreflector element 1, and extending from the back 4 of the retroreflector element 1. The length of this mounting bracket 34 is more than twice the distance between the front and back of the retroreflector element 1.

At its outer end, the mounting bracket 34 has numerous lugs 35 that engage in the pockets in the frame (not shown).

The lateral fastener 32 can be attached at the lugs 35 to the frame (not shown) with a thermal bond, adhesive, or weld, in particular a laser weld.

The mounting bracket 34 can also have fasteners with which it can be screwed to the lateral fasteners 32 on the frame.

Instead of the lugs 35, there could be holes or slots in the mounting bracket 34 forming fasteners, in particular for screws.

It is understood that at least the fastening plate 33 is made of the same material as the retroreflector elements. The mounting bracket 34 is also preferably made of the same material as the retroreflector element 1.

### LIST OF REFERENCE SYMBOLS

1 retroreflector element
2 light-entry surface
3, 3′, 3″ reflecting surfaces
4 back surface
5 lateral surfaces
6 edges
7 light beam
8 light beam
9 light beam
10 angle of incidence
11 retroreflector element
12 retroreflector element
13 retroreflector element
14 retroreflector unit
15 core part
16 shell part
17 housing
18 edge
19 1^{st} flange
20 web
21 2^{nd} flange
22 disk
23 frame
24 collar
25 edge contour
26 fastening plate
27 fastening elements
28 pockets
29 frame
30 opening
31 front
32 lateral fastener
33 fastening plate
34 mounting bracket
35 lug
N normal
a distance

We claim:

1. A retroreflector for vehicles, the retroreflector comprising:
a retroreflector element containing:
numerous reflecting surfaces at an angle to one another, at which light entering the retroreflector element is reflected back toward its source, and
a light-entry surface;
wherein the reflecting surfaces are on a back surface of the retroreflector element lying opposite the light-entry surface and/or on a lateral surface connecting the light-entry surface to the back surface,
wherein opposing edges of the light-entry surface are at a distance (a) of at least 5 mm to one another, and
wherein at least one fastening element protrudes from the retroreflector element.

2. The retroreflector according to claim 1, wherein the light-entry surface is flat or slightly curved.

3. The retroreflector according to claim 1, wherein a projection of the light-entry surface onto a surface perpendicular to a normal (N) thereof covers the reflecting surfaces and the lateral surfaces.

4. The retroreflector according to claim 1, wherein the retroreflector element is a polyhedron.

5. The retroreflector according to claim 1, wherein numerous retroreflector elements are spaced apart from one another, wherein spaces between retroreflector elements are filled by optical elements for signal lights, or form an opaque surface.

6. The retroreflector according to claim 1, wherein numerous retroreflector elements are arranged in a geometrical pattern or shape on a frame.

7. The retroreflector according to claim 6, wherein the retroreflector element has fastening elements protruding laterally therefrom, such that the retroreflector element can be placed in an opening in the frame from behind, where it is attachable to the frame.

8. The retroreflector according to claim 7, wherein the fastening element is on the light-entry surface of the retroreflector element, wherein an edge contour of a fastening collar and/or plate is used to retain it securely in the opening in the frame.

9. The retroreflector according to claim 8, wherein the edge contour of the fastening collar and/or plate corresponds to the inner shape of the opening in the frame.

10. The retroreflector according to claim 1, wherein numerous adjacent retroreflector elements are integrally connected to one another to form a retroreflector unit.

11. The retroreflector according to claim 10, wherein fastening elements are formed on sides of the retroreflector element and/or retroreflector unit that fit into pockets in the frame.

12. The retroreflector according to claim 11, wherein the pockets in the frame retain the retroreflector element or retroreflector unit in a form-fitting manner after it has been placed in an opening in a frame from behind.

13. The retroreflector according to claim 11, wherein the retroreflector element and/or retroreflector unit has a lateral fastener on just one side with a fastening plate that covers the light-entry surface and a mounting bracket integrally connected to the fastening plate, which extends from the fastening plate over the back of the retroreflector element or retroreflector unit at the side thereof.

14. The retroreflector according to claim 13, wherein the mounting bracket has lugs with which it is attached to the frame.

15. The retroreflector according to claim 13, wherein the mounting bracket has fasteners screwed to the frame.

16. The retroreflector according to claim 5, wherein spaces between retroreflector elements are filled by an opaque surface, which is the vehicle body.
